(19) United States
(12) Patent Application Publication
(10) Pub. No.: US 2024/0429750 A1
(43) Pub. Date: Dec. 26, 2024

(54) WIRELESS POWER RECEPTION DEVICE, WIRELESS POWER SUPPLY SYSTEM AND WIRELESS POWER RECEPTION METHOD

(71) Applicant: KABUSHIKI KAISHA TOSHIBA, Tokyo (JP)

(72) Inventors: Kazuki ARAI, Yokohama Kanagawa (JP); Toshiya MITOMO, Yokohama Kanagawa (JP)

(73) Assignee: KABUSHIKI KAISHA TOSHIBA, Tokyo (JP)

(21) Appl. No.: 18/606,863

(22) Filed: Mar. 15, 2024

(30) Foreign Application Priority Data
Jun. 21, 2023 (JP) 2023-102050

(51) Int. Cl. H02J 50/20; H02J 50/80

(52) U.S. Cl. CPC H02J 50/20; H02J 50/80

(57) ABSTRACT

According to one embodiment, a wireless power reception device, includes: a power receiver circuit configured to receive RF power by separating the RF power into first RF power derived from a first linear polarization component and second RF power derived from a second linear polarization component; a first converter circuit configured to convert the first RF power into first DC power; a second converter circuit configured to convert the second RF power into second DC power; a combiner circuit configured to combine the first DC power and the second DC power in parallel, and output the combined DC power as third DC power; and a voltage fixer circuit configured to fix an output voltage of the combiner to a predetermined value, wherein the first converter and the second converter operate to maximize power conversion efficiencies of the first converter and the second converter, respectively.

### CROSS REFERENCE TO RELATED APPLICATIONS

This application is based upon and claims the benefit of priority from the prior Japanese Patent Application No. 2023-102050, filed on Jun. 21, 2023, the entire contents of which are incorporated herein by reference.

### FIELD

The present embodiment relates to a wireless power reception device, a wireless power supply system and a wireless power reception method.

### BACKGROUND

In the wireless power supply technology using electromagnetic waves as power channels, linear polarizations, circular polarizations and the like are used. Electric power transmitted from the power transmission side to the power reception side at this time is referred to as RF power (Radio Frequency Electric Power). When RF power is received, polarization loss occurs depending on the polarization angle, and the magnitude of the received power changes.

### BRIEF DESCRIPTION OF THE DRAWINGS

FIG. 1 is a diagram illustrating a configuration of a wireless power supply system according to embodiment 1;

FIG. 2 is diagram illustrating a detailed configuration of a converter of a wireless power reception device;

FIG. 3 is a diagram illustrating ideal received power characteristics of RF power;

FIG. 4 is a diagram illustrating relationship between input power and power conversion efficiency at a time of an optimal load;

FIG. 5 is a diagram illustrating relationship between input power and output voltage;

FIG. 6 is a diagram illustrating an example of a measurement result of received DC power of the wireless power reception device;

FIG. 7 is a diagram illustrating a configuration of a wireless power supply system according to embodiment 2; and

FIG. 8 is a diagram illustrating a configuration of a wireless power supply system according to embodiment 3.

### DETAILED DESCRIPTION

According to one embodiment, a wireless power reception device, includes: a power receiver circuit configured to receive RF power by separating the RF power into first RF power derived from a first linear polarization component and second RF power derived from a second linear polarization component; a first converter circuit configured to convert the first RF power into first DC power; a second converter circuit configured to convert the second RF power into second DC power; a combiner circuit configured to combine the first DC power and the second DC power in parallel, and output the combined DC power as third DC power; and a voltage fixer circuit configured to fix an output voltage of the combiner to a predetermined value, wherein the first converter and the second converter operate to maximize power conversion efficiencies of the first converter and the second converter, respectively.

According to one embodiment, a wireless power supply system includes a wireless power transmission device configured to transmit RF power; and the above wireless power reception device.

According to one embodiment, a wireless power reception method includes: receiving RF power by separating the RF power into first RF power derived from a first linear polarization component and second RF power derived from a second linear polarization component; converting the first RF power into first DC power; converting the second RF power into second DC power; combining the first DC power and the second DC power in parallel, and outputting the combined DC power as third DC power; and fixing an output voltage of a combiner to a predetermined value, wherein conversion from the first RF power into the first DC power, and conversion from the second RF power into the second DC power each operate to maximize power conversion efficiencies.

Hereinafter, present embodiments will be described with reference to the drawings. In the drawings, the same or corresponding elements are assigned with the same reference signs, and detailed explanation is omitted as appropriate.

### Embodiment 1

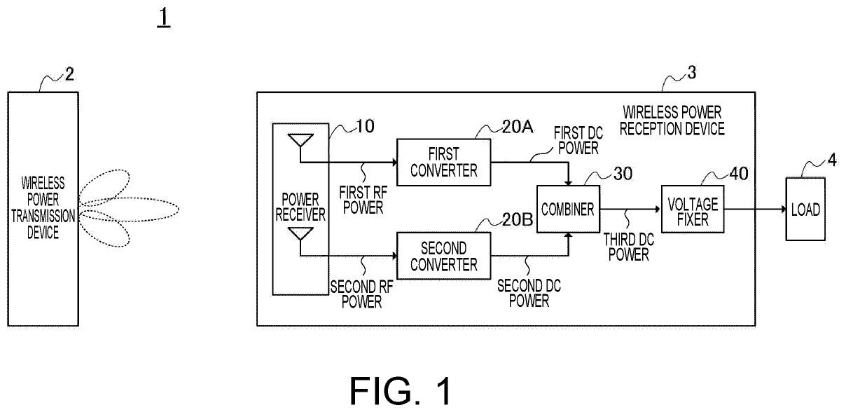

FIG. 1 is a diagram illustrating a configuration of a wireless power supply system 1 according to embodiment 1. The wireless power supply system 1 includes a wireless power transmission device 2 that transmits RF power using any polarization method such as a linear polarization or a circular polarization, and a wireless power reception device 3 that receives the RF power transmitted from the wireless power transmission device 2. The RF power received by the wireless power reception device 3 is converted into DC power and supplied to a load 4. The wireless power reception device 3 may be referred to as a power reception device 3.

Electromagnetic waves used in transmission of RF power include not only microwaves, millimeter waves, submillimeter waves and the like but also light waves such as infrared light, visible light, and X-rays. The frequency of electromagnetic waves becomes the frequency of RF power.

In the present embodiment 1, the wireless power transmission device 2 mainly uses microwaves as the electromagnetic waves for use in transmission of RF power. Usually, the frequency of microwave is defined as 3 to 30 GHz, which has an advantage of being less likely to be blocked than millimeter and submillimeter waves having higher frequencies, and light waves having lower frequencies. Note that the wireless power transmission device 2 may include a function of controlling a transmission amount of RF power.

The wireless power reception device 3 includes a power receiver 10, a first converter 20A, a second converter 20B, a combiner 30, and a voltage fixer 40. The power receiver 10, the first converter 20A, the second converter 20B, the combiner 30 and the voltage fixer 40 may be configured by circuits, respectively, as a first converter circuit, a second converter circuit, a combiner circuit and a voltage fixer circuit.

The power receiver 10 has a configuration shared by two orthogonal polarizations, which is capable of receiving two orthogonal linear polarization components, receives the RF power transmitted from the wireless power transmission device 2 by separating it into two orthogonal polarization components, and outputs the RF power as first RF power and second RF power. The power receiver 10 may be capable of simultaneously receiving two orthogonal linear polarization components. The power receiver 10 may receive power by using a single antenna, or may receive power by using an antenna with a plurality of single polarization antennas orthogonal to each other.

The first converter 20A converts the first RF power outputted from the power receiver 10 into first DC power and outputs the first DC power. The second converter 20B converts the second RF power outputted from the power receiver 10 into second DC power and outputs the second DC power. As described later, the first converter 20A and the second converter 20B operate to maximize power conversion efficiencies of themselves.

The combiner 30 combines the first DC power outputted from the first converter 20A and the second DC power outputted from the second converter 20B in parallel, and outputs the combined DC power as third DC power. The voltage fixer 40 fixes the output voltage of the combiner 30 to a predetermined value.

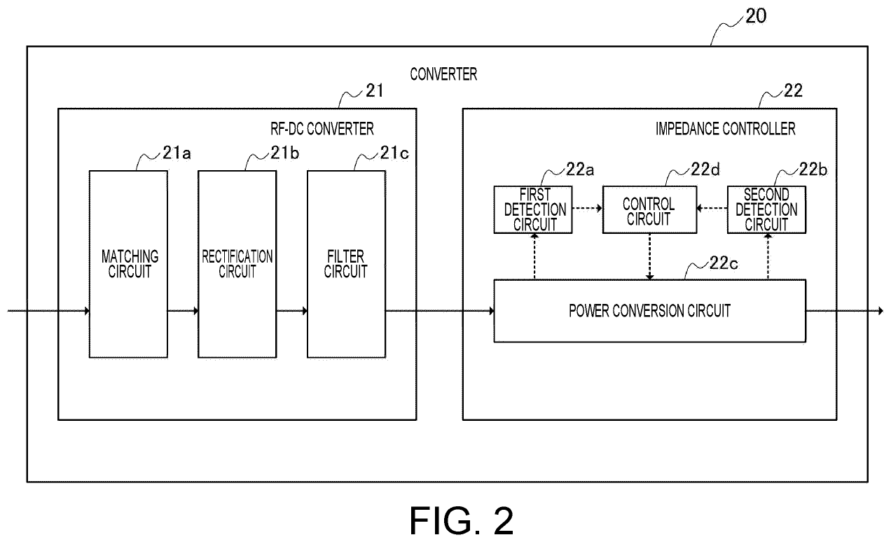

FIG. 2 is a diagram illustrating a detailed configuration of the first converter 20A and the second converter 20B. Note that the configurations of the first converter 20A and the second converter 20B are the same, these converters are collectively denoted as a converter 20 in FIG. 2.

The converter 20 includes an RF-DC converter 21 that converts the RF power outputted from the power receiver 10 into DC power, and an impedance controller 22 (or an impedance controller circuit) that is connected to a rear stage of the RF-DC converter 21.

The RF-DC converter 21 includes a matching circuit 21a, a rectification circuit 21b, and a filter circuit 21c. The matching circuit 21a matches impedance of the power receiver 10 and impedance of the rectification circuit 21b. Thereby, reflection of RF power inputted from the power receiver 10 is suppressed, and received power of the rectification circuit 21b increases. The matching circuit 21a can restrain weak RF power reflected by the rectification circuit 21b and harmonics generated by a rectification operation of the rectification circuit 21b from being reradiated into a space from the power receiver 10.

The rectification circuit 21b converts RF power inputted via the matching circuit 21a into DC power and outputs the DC power. The filter circuit 21c blocks weak RF power and harmonic components contained in the DC power outputted from the rectification circuit 21b, and passes only DC components. Note that the weak RF power and the harmonics that are blocked by the filter circuit 21c are reflected to the rectification circuit 21b.

The impedance controller 22 controls impedance on an output side seen from the RF-DC converter 21, that is, load impedance. When the load impedance is constant, the power conversion efficiency of the RF-DC converter 21 monotonously increases with increase in input powerup to a certain power. In other words, if the input power is small, the power conversion efficiency is low. The impedance controller 22 controls the load impedance of the RF-DC converter 21 so that the power conversion efficiency of the RF-DC converter 21 at a given input voltage is maximized.

Here, the load impedance of the RF-DC converter 21, which maximizes the power conversion efficiency at the given input power is defined as an “optimal load impedance”. The impedance controller 22 controls the load impedance of the RF-DC converter 21 so that the load impedance of the RF-DC converter 21 is kept in a vicinity of the optimal load impedance by performing power conversion. Here, the load impedance being “kept in the vicinity” of the optimal load impedance means that an error between the optimal load impedance and actual load impedance is kept within ±20%.

The impedance controller 22 includes a first detection circuit 22a, a second detection circuit 22b, a power conversion circuit 22c, and a control circuit 22d.

The first detection circuit 22a detects an input voltage and an input current of the impedance controller 22. The second detection circuit 22b detects an output voltage and an output current of the impedance controller 22.

The power conversion circuit 22c controls an input voltage of itself, and an input current or an output current, based on a command signal from the control circuit 22d. As a control method at this time, for example, PWM (Pulse Wide Modulation) control or PFM (Pulse Frequency Modulation) control or the like can be used. However, control methods other than the above may be used.

The control circuit 22d controls the operation of the power conversion circuit 22c based on the detection values of the first detection circuit 22a and the second detection circuit 22b, so that the power conversion efficiency of the RF-DC converter 21 is maximized, in other words, the output power of the RF-DC converter 21 is kept at a maximum value. As a control method at this time, for example, a hill-climbing method used in maximum power point tracking (MPPT: Maximum Power Point Tracking) can be used. Specifically, the control circuit 22d transmits a step-up instruction of an input voltage to the power conversion circuit 22c, and when the input voltage of the power conversion circuit 22c rises, the control circuit 22d confirms the detection values of the first detection circuit 22a and the second detection circuit 22b again.

When the output power of the RF-DC converter 21 calculated based on the new detection value is larger than the output power of the RF-DC converter 21 calculated based on a previous detection value, the control circuit 22d transmits a further step-up instruction to the power conversion circuit 22c. On the other hand, when the output power of the RF-DC converter 21 calculated based on the new detection value is smaller than the output power of the RF-DC converter 21 calculated based on the previous detection value, the control circuit 22d transmits a step-down instruction to the power conversion circuit 22c. When the output power of the RF-DC converter 21 calculated based on the new detection value, and the output power of the RF-DC converter 21 calculated based on the previous detection value are the same, the control circuit 22d does not transmit a step-up or step-down instruction to the power conversion circuit 22c. When the output power continues to decrease before and after the control, the next step-up/down command is reversed, and thereby the output power is maximized by a climbing method.

Next, effects of the first converter 20A and the second converter 20B of the wireless power reception device 3 according to the present embodiment 1 will be described.

First, a case where the first converter 20A and the second converter 20B are removed, in the wireless power reception device 3 in FIG. 1 is considered. In this case, in the combiner 30, two RF powers outputted from the power receiver 10 are directly combined in parallel as the RF power.

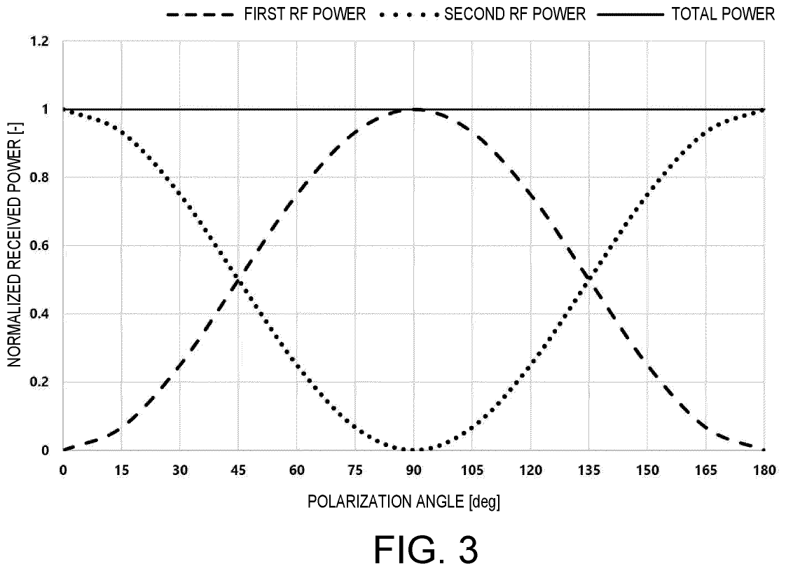

FIG. 3 is a diagram illustrating ideal received power characteristics of the RF power in the power receiver 10. In this drawing, the first RF power is received power derived from the first polarization component, and the second RF power is received power derived from the second polarization component. Further, a polarization angle on a horizontal axis is the polarization angle of the first polarization component and the second polarization component when the first polarization component is used as a reference. Normalized received power on a vertical axis is received power normalized by maximum received power.

As illustrated in FIG. 3, the first RF power and the second RF power both change sinusoidally with respect to the change in polarization angle, but total power of them always has a constant value without depending on the polarization angle. However, such received power characteristics are ideal, ignoring effects of nonlinear elements such as cross-polarization characteristics and materials of the antenna. From the drawing, it is understood that by configuring the power receiver 10 to be shared by two orthogonal polarizations, the maximum received power can always be obtained without depending on the polarization angle under the ideal conditions.

However, the maximum received power in FIG. 3 is calculated by simply adding up absolute values of the first RF power and the second RF power, and has a problem when both of them are actually combined in parallel as the RF power. The problem arises when there is a power difference between the first RF power and the second RF power. In this case, when the both are combined in parallel in the state of RF powers, respectively, loss in an RF power combining part and input power are made to flow into the other input power source or the like. Thus, the output power after the RF power combining is decreased.

Next, a case where the impedance controller 22 is removed while the RF-DC converter 21 is left, in the converter 20 in FIG. 2 is considered. In this case, in the combiner 30, two DC powers outputted from the RF-DC converter 21 are combined in parallel.

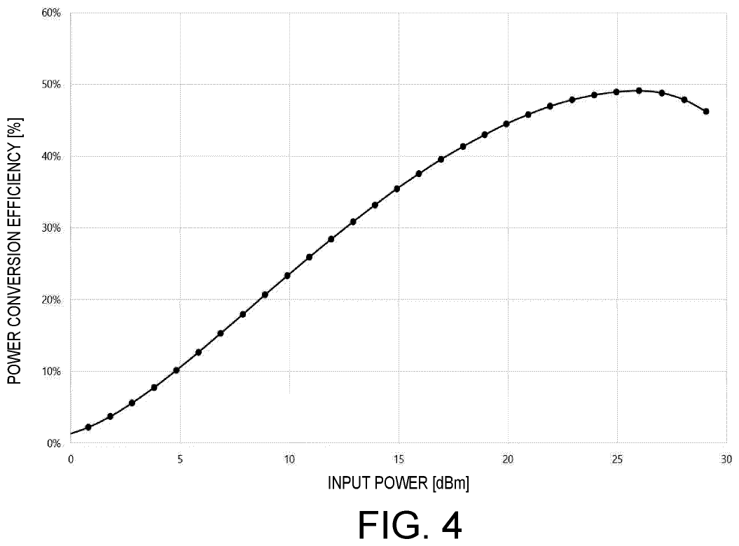

FIG. 4 is a diagram illustrating relationship between input power in an ordinary rectification circuit, and a power conversion efficiency at the time of an optimal load. As illustrated in the drawing, the power conversion efficiency of the rectification circuit changes depending on the magnitude of the input power. Therefore, when the magnitudes of the two RF powers become uneven depending on the polarization angle as in FIG. 3, the power conversion efficiencies of the two rectification circuits at a given polarization angle become different.

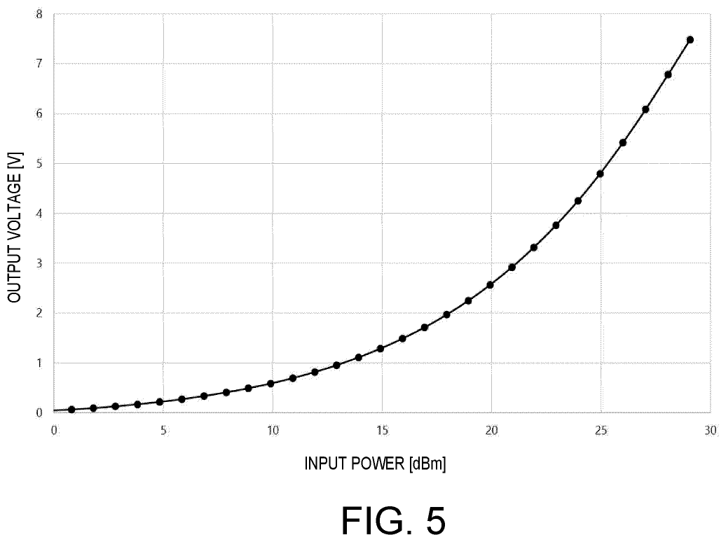

FIG. 5 is a diagram illustrating relationship between an input power and an output voltage in the rectification circuit under the same conditions as in FIG. 4. As illustrated in the drawing, the output voltage of the rectification circuit changes depending on the magnitude of the input power. Therefore, when the magnitudes of the two RF powers become uneven depending on the polarization angle as in FIG. 3, output voltages of the two rectification circuits at a given polarization angle become different.

When these two different output voltages are directly inputted to the combiner 30, these two output voltages are fixed to one common value in the combiner 30. When the output voltages of the two rectification circuits are fixed to the one common value, the output voltages are fixed to an output voltage different from the output voltage at which the maximum efficiency corresponding to the input power is obtained. In other words, the respective two rectifiers operate under conditions different from the optimal load impedance. As a result, it becomes difficult to simultaneously maximize power conversion efficiencies of the two rectification circuits.

In order to cope with the above-described problem, in the first converter 20A and the second converter 20B according to the present embodiment 1, the impedance controller 22 is provided at a rear stage of the RF-DC converter 21. The impedance controller 22 controls the load impedance of the RF-DC converter 21 so that the power conversion efficiency is maximized in response to the input power of the RF-DC converter 21. Specifically, the impedance controller 22 controls the load impedance of the RF-DC converter 21 so that the load impedance of the RF-DC converter 21 is kept in the vicinity of the optimal impedance.

Next, an effect of the voltage fixer 40 of the wireless power reception device 3 according to the present embodiment 1 will be described.

First, in the wireless power reception device 3 in FIG. 1, a case where the voltage fixer 40 is removed is considered. In this case, for example, when the output currents of the first converter 20A and the second converter 20B fluctuate, the output voltage of the combiner 30 fluctuates in association with this. When the output voltage of the combiner 30 fluctuates, the output voltages of the first converter 20A and the second converter 20B also fluctuate in association with this. When the output voltages of the first converter 20A and the second converter 20B fluctuate, the impedance controllers 22A and 22B included in both the converters 20A an 20B also operate in response to this. Like this, since the output voltage always fluctuates, the input and output voltages of the impedance controllers 22A and 22B constantly fluctuate along with the input side which is the original control target, and as a result, control to maximize the power conversion efficiencies of both of them becomes difficult.

In order to solve the problem as described above, the voltage fixer 40 fixes the output voltage of the combiner 30 to a predetermined value. As a result that the output voltage of the combiner 30 is fixed to the predetermined value, the output voltages of the first converter 20A and the second converter 20B are also fixed to the predetermined value in association with this. If the output voltages of the first converter 20A and the second converter 20B are fixed to the predetermined value, the impedance controllers 22A and 22B of both of them can individually control load impedance on the respective input sides, that is, the RF-DC converters 21A and 21B in response to the powers inputted to the RF-DC converters 21A and 21B with the fixed output voltages as the reference. As a result, the control to maximize the power conversion efficiencies of both of them is facilitated.

Here, definition of the term “fix” in the present embodiment 1 will be described. During operation of the wireless power reception device 3, the output voltage of the combiner 30 slightly fluctuates with a predetermined value determined by the voltage fixer 40 as the target, and in this process, an error occurs between the predetermined value as the target and an actual output voltage. When the range of the error is defined as a voltage fluctuation ratio (=(actual output voltage−predetermined value)/predetermined value), in the present embodiment 1, the output voltage being fixed to the predetermined value means that the voltage fluctuation ratio of the output voltage is within ±20% around the predetermined value.

The voltage fixer 40 has a function of performing constant voltage control of the output voltage of itself, and includes a power supply circuit with small internal resistance. The voltage fixer 40 performs constant voltage control of the output voltage of itself so that the voltage applied to itself, that is, the output voltage of the combiner 30 is fixed to the above-described predetermined value. The internal resistance of the voltage fixer 40 is small, and therefore, even when the output currents of the first converter 20A and the second converter 20B fluctuate, the voltage applied to the voltage fixer 40, that is, the output voltage of the combiner 30 hardly fluctuates.

The respective impedance controllers 22 included in the first converter 20A and the second converter 20B can independently perform control of the load impedance of the RF-DC converter 21, specifically, the control to keep the load impedance in the vicinity of the optimal load impedance without being influenced by the operation status of each other.

As described above, the wireless power reception device 3 according to the present embodiment 1 includes the power receiver 10 that receives the RF power by separating the RF power into the first RF power derived from the first polarization component and the second RF power derived from the second polarization component, the first converter 20A that converts the first RF power into the first DC power, the second converter 20B that converts the second RF power into the second DC power, the combiner 30 that combines the first DC power and the second DC power in parallel and outputs the combined DC power as the third DC power, and the voltage fixer 40 that fixes the output voltage of the combiner 30 to a predetermined value. The first converter 20A and the second converter 20B operate to maximize the power conversion efficiencies of themselves.

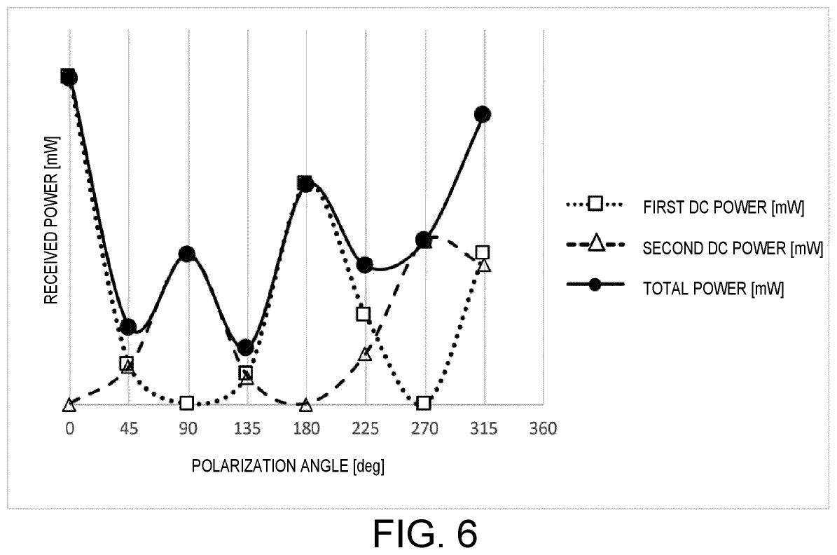

According to the characteristics as described above, the wireless power reception device 3 according to the present embodiment 1 can suppress influence of the polarization loss when receiving the RF power. FIG. 6 is one example of an actual measurement result of the received power of the wireless power reception device 3. Although the magnitudes of the two RF powers differ in the given polarization angle, RF-DC conversion is performed to the respective RF powers, and by combining the powers derived from the respective polarization components, fluctuation of the total received power to the polarization angle is relaxed.

Note that the voltage fixer 40 may be able to store the DC power outputted from the combiner 30. In this case, as the voltage fixer 40, for example, a storage battery can be used. The internal resistance of the storage battery is small, and therefore, even if the current flowing in the storage battery fluctuates, electromotive force of the storage battery is kept at a constant voltage according to a remaining amount of stored electricity of the battery. The power stored in the storage battery can be supplied to the load 4, switches of embodiment 3 described later and the like. Further, the voltage fixer 40 may have a function of adjusting the output voltage to a suitable voltage to the load 4, the switches of embodiment 3, or the like.

### Embodiment 2

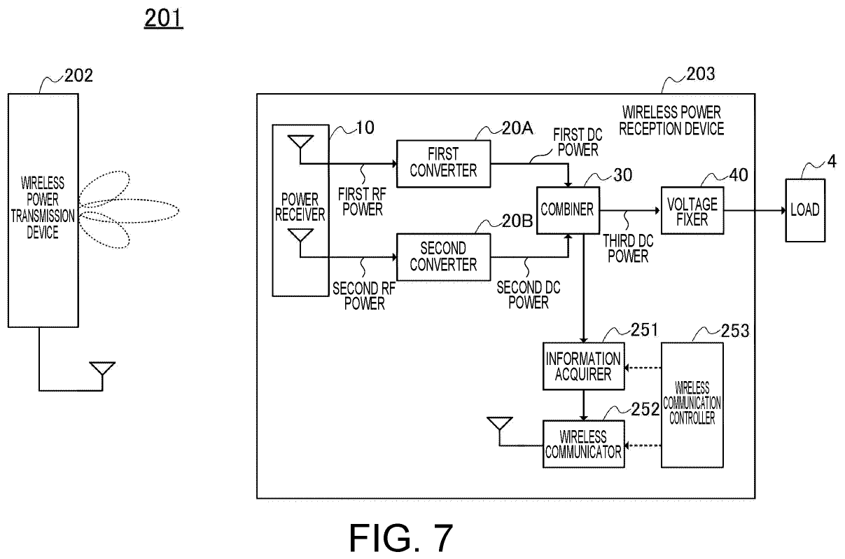

FIG. 7 is a diagram illustrating a configuration of a wireless power supply system 201 according to embodiment 2. A wireless power reception device 203 includes an information acquirer 251, a wireless communicator 252 (or a wireless communication circuit), and a wireless communication controller 253 in addition to the respective components of the wireless power reception device 3 of embodiment 1. The information acquirer 251, the wireless communicator 252, and the wireless communication controller 253 may be configured by circuits, respectively, such as an information acquirer circuit, a wireless communication circuit and a wireless communication controller circuit.

The information acquirer 251 acquires information concerning received power of the wireless power reception device 203. The information concerning the received power includes, for example, information of a voltage and a current of third DC power outputted from a combiner 30, information of voltages and currents of first RF power and second RF power that are inputted to a first converter 20A and a second converter 20B, information of voltages and currents of first DC power and second DC power that are outputted from the first converter 20A and the second converter 20B and the like. Further, when a voltage fixer 40 can store power, information of an amount of power stored in the voltage fixer 40 may be included as information concerning the received power.

The wireless communicator 252 transmits and receives various kinds of information including the information concerning the received power described above to and from a wireless power transmission device 202 and the wireless power reception device 203 by wireless communication. For example, the wireless power transmission device 202 can determine a power supply schedule such as timing of power supply, and an amount of power supply based on the information concerning the received power, which is transmitted from the wireless power reception device 203. The wireless communication controller 253 controls operations of the information acquirer 251 and the wireless communicator 252.

As a scheme of wireless communication between the wireless power transmission device 202 and the wireless power reception device 203, for example, Bluetooth (registered trademark), ZigBee (registered trademark), specified low power wireless communication, wireless LAN (Wireless Local Area Network), or the like can be used.

As described above, the wireless power reception device 203 according to the present embodiment 2 includes the information acquirer 251 that acquires the information concerning the received power of the wireless power reception device 203, and the wireless communicator 252 that transmits the information concerning the received power by wireless communication. According to such a feature, the wireless power transmission device 202 can determine the power supply schedule such as the timing of power supply, and the amount of power supply based on the information concerning the received power, which is transmitted from the wireless power reception device 203.

### Embodiment 3

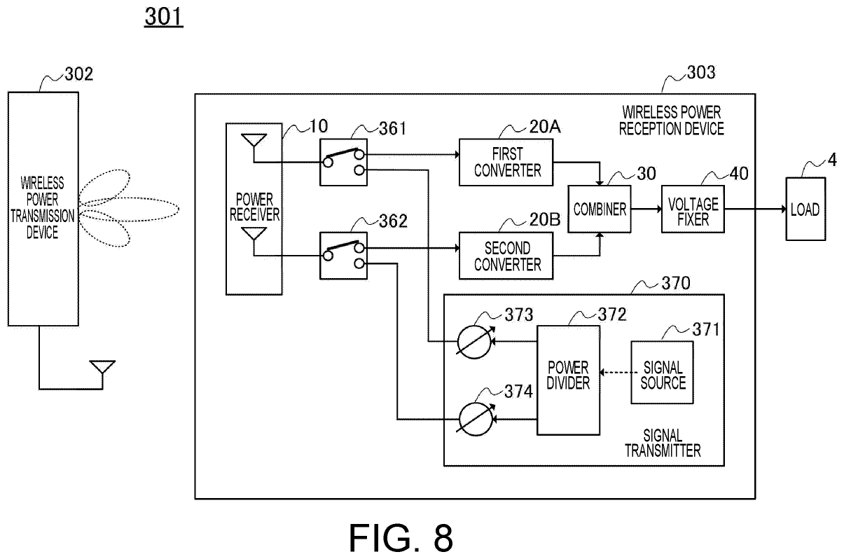

FIG. 8 is a diagram illustrating a configuration of a wireless power supply system 301 according to embodiment 3. A wireless power reception device 303 includes a first switch 361, a second switch 362, and a signal transmitter 370 (or a signal transmission circuit) in addition to the respective components of the wireless power reception device 3 of embodiment 1.

The first switch 361 is provided between a power receiver 10 and a first converter 20A. The first switch 361 switches between a first connection state where the power receiver 10 and the first converter 20A are electrically connected, and a second connection state where the power receiver 10 and the first converter 20A are electrically disconnected. In the second connection state, the power receiver 10 and a first phase shifter 373 of the signal transmitter 370 are electrically connected.

The second switch 362 is provided between the power receiver 10 and a second converter 20B. The second switch 362 switches between a first connection state where the power receiver 10 and the second converter 20B are electrically connected, and a second connection state where the power receiver 10 and the second converter 20B are electrically disconnected. In the second connection state, the power receiver 10 and a second phase shifter 374 of the signal transmitter 370 are electrically connected.

When a voltage fixer 40 can store power, the first switch 361 and the second switch 362 can operate by the power stored in the voltage fixer 40.

When a power storage amount of the voltage fixer 40 is less than a predetermined threshold, the first switch 361 may be in the first connection state where the power receiver 10 and the first converter 20A are connected. On the other hand, when the power storage amount of the voltage fixer 40 is the predetermined threshold or more, the first switch 361 may be in the second connection state where the power receiver 10 and the first converter 20A are disconnected. The predetermined threshold may be set in advance based on performance of the voltage fixer 40 or may be set by a user.

When the power storage amount of the voltage fixer 40 is less than the predetermined threshold, the second switch 362 may be in the first connection state where the power receiver 10 and the second converter 20B are connected. On the other hand, when the power storage amount of the voltage fixer 40 is the predetermined threshold or more, the second switch 362 may be in the second connection state where the power receiver 10 and the second converter 20B are disconnected. The predetermined threshold may be set in advance based on the performance of the voltage fixer 40 or may be set by the user.

When the first switch 361 and the second switch 362 are in the second connection states, the signal transmitter 370 can transmit any signal such as a beacon signal using an unmodulated wave or any modulation method toward the wireless power transmission device 302 via the power receiver 10.

The signal transmitter 370 includes a signal source 371, a power divider 372 capable of any power distribution, the first phase shifter 373 and the second phase shifter 374 capable of generating any phase difference. Note that the first phase shifter 373 and the second phase shifter 374 do not have to be necessarily included, and only the power divider 372 may be included.

The wireless power transmission device 302 can estimate a position of the wireless power reception device 303, information of channel between the wireless power transmission device 302 and the wireless power reception device 303, and the like based on a direction in which the above-described beacon signal is received and received signal strength and the like.

When the voltage fixer 40 can store power, the signal transmitter 370 can operate by the power stored in the voltage fixer 40. A frequency of the beacon signal transmitted by the signal transmitter 370 is preferably the same as a frequency of RF power transmitted by the wireless power transmission device 302, but may be a different frequency.

In the present embodiment 3, a case where the same frequency is used in transmission of RF power and transmission of the beacon signal will be described. In this case, it is possible to switch transmission of the RF signal and transmission of the beacon signal in a time-division manner by switching the connection states of the first switch 361 and the second switch 362. This prevents interference of the RF power and the beacon signal.

The signal transmitter 370 can make the beacon signal transmitted from the power receiver 10 shared by two orthogonal polarizations have any polarization. For example, by setting the power divider 372 to equal distribution and setting the phase difference of the first phase shifter 373 and the second phase shifter 374 to 90 degrees, it is possible to transmit a beacon signal of a circular polarization from the power receiver 10 shared by two orthogonal polarizations. Since a beacon signal of any polarization can be transmitted from the wireless power reception device 303, so-called polarization diversity can be realized.

As described above, the wireless power reception device 303 according to the present embodiment 3 includes the first switch 361 provided between the power receiver 10 and the first converter 20A, the second switch 362 provided between the power receiver 10 and the second converter 20B, and the signal transmitter 370. The first switch 361 and the second switch 362 switch between the first connection state where the power receiver 10 and the first converter 20A and the second converter 20B are electrically connected, and the second connection state where the power receiver 10 and the signal transmitter 370 are electrically connected. At this time, the signal transmitter 370 may include an over-input protection or the like so as not to be broken by receiving the received power from the power receiver 10 in the second connection state.

By the feature described above, the wireless power reception device 303 according to the present embodiment 3 can transmit any signal such as a beacon signal from the power receiver 10. The wireless power transmission device 302 can estimate a position of the wireless power reception device 303, and information of the channel between the wireless power transmission device 302 and the wireless power reception device 303 and the like, based on the direction in which the beacon signal is received, the reception signal strength, and the like.

Note that the voltage fixer 40 may set an upper limit value of a charging current flowing into itself. For example, when the charging current exceeding a predetermined upper limit value is detected, the voltage fixer 40 may electrically disconnect the power receiver 10 and at least one of the first converter 20A and the second converter 20B by controlling the first switch 361 and the second switch 362. Thereby, the voltage fixer 40 can be protected from an excessive charging current. At this time, when only one of the converters is disconnected, charge can be continued by a charging current supplied from the remaining converter.

The voltage fixer 40 may set a lower limit value of a charging voltage applied to itself. For example, when a charging voltage less than a predetermined lower limit value is detected, the voltage fixer 40 may electrically disconnect itself from output of the combiner 30 by controlling the first switch 361 and the second switch 362. Thereby, when the charging voltage is excessively low, the voltage fixer 40 can be protected from an excessive charging current.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### Clauses

Clause 1. A wireless power reception device, comprising:
a power receiver circuit configured to receive RF power by separating the RF power into first RF power derived from a first linear polarization component and second RF power derived from a second linear polarization component;
a first converter circuit configured to convert the first RF power into first DC power;
a second converter circuit configured to convert the second RF power into second DC power;
a combiner circuit configured to combine the first DC power and the second DC power in parallel, and output the combined DC power as third DC power; and
a voltage fixer circuit configured to fix an output voltage of the combiner to a predetermined value, wherein
the first converter and the second converter operate to maximize power conversion efficiencies of the first converter and the second converter, respectively.

Clause 2. The wireless power reception device according to claim 1, wherein
each of the first converter and the second converter includes
an RF-DC converter configured to convert RF power into DC power, and
an impedance controller circuit configured to perform control so that load impedance of the RF-DC converter is kept in a vicinity of optimal load impedance.

Clause 3. The wireless power reception device according to claim 1 or 2, wherein the voltage fixer circuit is capable of storing the third DC power.

Clause 4. The wireless power reception device according to claim 3, wherein the voltage fixer circuit includes a storage battery.

Clause 5. The wireless power reception device according to any one of claims 1 to 4, further comprising:
a circuit configured to acquire information concerning received power of the wireless power reception device; and
a wireless communication circuit configured to transmit the information concerning the received power by wireless communication.

Clause 6. The wireless power reception device according to claim 5, wherein the information concerning the received power includes at least one of information of a voltage and a current of the third DC power, information of voltages and currents of the first RF power and the second RF power, and information of voltages and currents of the first DC power and the second DC power.

Clause 7. The wireless power reception device according to any one of claims 1 to 6, further comprising:
a first switch provided between the power receiver and the first converter, and configured to switch between a first connection state where the power receiver and the first converter are electrically connected, and a second connection state where the power receiver and the first converter are electrically disconnected; and
a second switch provided between the power receiver and the second converter, and configured to switch between a first connection state where the power receiver and the second converter are electrically connected, and a second connection state where the power receiver and the second converter are electrically disconnected.

Clause 8. The wireless power reception device according to claim 7, further comprising:
a signal transmission circuit, wherein
the first switch and the second switch electrically connect the power receiver and the signal transmission circuit in the second connection states.

Clause 9. The wireless power reception device according to claim 8, wherein the signal transmission circuit includes a power divider capable of any power distribution.

Clause 10. The wireless power reception device according to claim 9, wherein the signal transmission circuit includes any one or both of a first phase shifter and a second phase shifter capable of generating any phase difference.

Clause 11. The wireless power reception device according to any one of claims 1 to 10, wherein
the second linear polarization component is orthogonal to the first linear polarization component.

Clause 12. A wireless power supply system, comprising:
a wireless power transmission device configured to transmit RF power; and
the wireless power reception device according to any one of claims 1 to 11.

Clause 13. A wireless power reception method, comprising:
receiving RF power by separating the RF power into first RF power derived from a first linear polarization component and second RF power derived from a second linear polarization component;
converting the first RF power into first DC power;
converting the second RF power into second DC power;
combining the first DC power and the second DC power in parallel, and outputting the combined DC power as third DC power; and
fixing an output voltage of a combiner to a predetermined value, wherein
conversion from the first RF power into the first DC power, and conversion from the second RF power into the second DC power each operate to maximize power conversion efficiencies.

1. A wireless power reception device, comprising:
a power receiver circuit configured to receive RF power by separating the RF power into first RF power derived from a first linear polarization component and second RF power derived from a second linear polarization component;
a first converter circuit configured to convert the first RF power into first DC power;
a second converter circuit configured to convert the second RF power into second DC power;
a combiner circuit configured to combine the first DC power and the second DC power in parallel, and output the combined DC power as third DC power; and
a voltage fixer circuit configured to fix an output voltage of the combiner to a predetermined value, wherein
the first converter and the second converter operate to maximize power conversion efficiencies of the first converter and the second converter, respectively.

2. The wireless power reception device according to claim 1, wherein
each of the first converter and the second converter includes
an RF-DC converter configured to convert RF power into DC power, and
an impedance controller circuit configured to perform control so that load impedance of the RF-DC converter is kept in a vicinity of optimal load impedance.

3. The wireless power reception device according to claim 1, wherein the voltage fixer circuit is capable of storing the third DC power.

4. The wireless power reception device according to claim 3, wherein the voltage fixer circuit includes a storage battery.

5. The wireless power reception device according to claim 1, further comprising:
a circuit configured to acquire information concerning received power of the wireless power reception device; and
a wireless communication circuit configured to transmit the information concerning the received power by wireless communication.

6. The wireless power reception device according to claim 5, wherein the information concerning the received power includes at least one of information of a voltage and a current of the third DC power, information of voltages and currents of the first RF power and the second RF power, and information of voltages and currents of the first DC power and the second DC power.

7. The wireless power reception device according to claim 1, further comprising:
a first switch provided between the power receiver and the first converter, and configured to switch between a first connection state where the power receiver and the first converter are electrically connected, and a second connection state where the power receiver and the first converter are electrically disconnected; and
a second switch provided between the power receiver and the second converter, and configured to switch between a first connection state where the power receiver and the second converter are electrically connected, and a second connection state where the power receiver and the second converter are electrically disconnected.

8. The wireless power reception device according to claim 7, further comprising:
a signal transmission circuit, wherein
the first switch and the second switch electrically connect the power receiver and the signal transmission circuit in the second connection states.

9. The wireless power reception device according to claim 8, wherein the signal transmission circuit includes a power divider capable of any power distribution.

10. The wireless power reception device according to claim 9, wherein the signal transmission circuit includes any one or both of a first phase shifter and a second phase shifter capable of generating any phase difference.

11. The wireless power reception device according to claim 1, wherein
the second linear polarization component is orthogonal to the first linear polarization component.

12. A wireless power supply system, comprising:
a wireless power transmission device configured to transmit RF power; and
the wireless power reception device according to claim 1.

13. A wireless power reception method, comprising:
receiving RF power by separating the RF power into first RF power derived from a first linear polarization component and second RF power derived from a second linear polarization component;
converting the first RF power into first DC power;
converting the second RF power into second DC power;
combining the first DC power and the second DC power in parallel, and outputting the combined DC power as third DC power; and
fixing an output voltage of a combiner to a predetermined value, wherein
conversion from the first RF power into the first DC power, and conversion from the second RF power into the second DC power each operate to maximize power conversion efficiencies.
